(19) United States
(12) Patent Application Publication
(10) Pub. No.: US 2010/0131534 A1
(43) Pub. Date: May 27, 2010

(54) INFORMATION PROVIDING SYSTEM

(76) Inventors: Toshio Takeda, Tokyo (JP); Susumu Akamine, Tokyo (JP); Satoshi Nakazawa, Tokyo (JP); Kai Ishikawa, Tokyo (JP)

Correspondence Address: Mr. Jackson Chen, 6535 N. STATE HWY 161, IRVING, TX, 75039, US

(21) Appl. No.: 12/595,334

(22) PCT Filed: Apr. 9, 2008
(86) PCT No.: PCT/JP2008/057010

§ 371 Date: Oct. 9, 2009

(30) Foreign Application Priority Data
Apr. 10, 2007 (JP) 2007-102895

(51) Int. Cl. G06F 17/30

(52) U.S. Cl. 707/758; 707/E17.008

(57) ABSTRACT

An information providing system comprises: an associated document determining unit that determines at least one piece of associated document data that includes an expression equal or similar to a cited section based on a cited section in document data; a limiting expression extraction unit that extracts an expression that corresponds to a condition for, correction for, addition to, or annotation to an expression equal or similar to the cited section from associated document data determined by the associated document determining unit; an information creation unit that creates an expression extracted by the limiting expression extraction unit or information regarding this expression as information to be displayed; and a display unit that displays information created by the information creation unit.

This application is the National Phase of PCT/JP2008/057010, filed Apr. 9, 2008, which is based upon and claims the benefit of the priority of Japanese patent application No. 2007-102895 filed on Apr. 10, 2007, the disclosure of which is incorporated herein in its entirety by reference thereto.

### FIELD OF THE INVENTION

The present invention relates to an information providing system, information providing method, and information providing program, and particularly to an information providing system, information providing method, and information providing program capable of displaying supplementary information about cited information.

### BACKGROUND

An electronic documents (abbreviated as “document” hereinafter) includes a cited sentence (cited section) clearly indicated by a tag in an HTML document, or for instance, a cited section such as a quoted sentence “The economy is recovering” quoted as an expression from a sentence: “the Prime Minister said, ‘The economy is recovering.’” The cited section contains a sentence selected from the source sentences, from which the section is cited, by the document publisher and edited by him. Therefore, a reader who reads the cited section may understand the cited section differently from the way it is presented in the original source. For instance, there are cases where limiting conditions for the cited section to be true written in the source or data supplementing the cited section are not provided, or cases where the meaning read only from the cited section is different from that from the source because there are contents related to the cited section before and after it in the source.

Information for a cited section to be understood accurately such as limiting conditions for the cited section to be true, reference data, and modifying expressions for the cited section will be called “supplementary information” to the cited section hereinafter.

One of the general methods for confirming the supplementary information in the source document is to, when the source document is on the Web and the link to it is provided, open the link using another browser and confirm the information. However, in this case, the source must be clearly identified and when it is not, the cited section must be searched on a search site. Further, it cannot be determined whether or not the link actually contains the sentences in the cited sections until one reads the document and confirms it.

Further, since the cited section is thought to include content that should be picked up as a discussion topic, it is likely that the section is cited in documents other than the source document and those currently referred to, and these documents may include the supplementary information as well. Documents that contain the cited section including the source document from which the section is cited and other document citing the same section will be referred to as “associated documents” hereinafter. Further, documents including notations on the cited section equal or similar to notations in the source document are included in the associated documents. In order to obtain supplementary information from an associated document, for instance, a character string of the cited section must be searched from a large number of documents, and supplementary information must be searched from an associated document having the character string by going through its contents.

Patent Document 1 describes an example of a conventional information providing system as a reference relation displaying device for electronic documents. For arguments using electronic documents, Patent Document 1 describes a method that provides a button at the end of a cited section in a referred document, inserts parts following the cited section in a reference document in steps, and displays them in the referred document when the button is operated.

When the method described in Patent Document 1 is applied to not only the relation between a referred document and reference document, but also to the relation between a cited section, and the source and associated documents, whether or not there is any reference can be determined by whether or not a button is provided. When a button is provided, it is not necessary to search for the source, and the fact that there are actually sentences following the cited section can be proved. However, one cannot be sure whether or not information relating to the cited section can be found in the sentences inserted in steps using the method of Patent Document 1 until he reads the inserted sentences. Further, one cannot determine whether or not there is supplementary information to the cited section besides the inserted sentences unless he further reads the source document, and this would require a lot of efforts.

Meanwhile, when a cited section is extracted from an HTML document, a blockquote element and q element indicating quotation are generally extracted for the purpose of having Web browser set the appearance of the cited section. Further, Patent Document 1 describes how a cited section is extracted from an email document utilizing a symbol at the beginning of a line indicating quotation.

[Patent Document 1]

Japanese Patent Kokai Publication No. JP-P2000-112980A

### SUMMARY

The entire disclosure of the above-mentioned Patent Document 1 is incorporated herein by reference thereto. An analysis on the related technology by the present inventor will be given below.

The technology that inserts and displays sentences following a cited section from an associated document in steps for the cited section has the following problems.

The first problem is that, in order to make sure whether or not supplementary information to a cited section or a notated section similar to the cited section exists in an associated document (including the source document) for the cited section, it is necessary to read unrelated sentences and confirm the contents of the associated document. The reason is that supplementary information to the cited section is not always located near the cited section. Further, in the method that simply inserts a predetermined amount of sentences following the cited section, since the inserted sentences are not always supplementary information relating to the cited section, the reader may have to read sentences that are not supplementary information, i.e., information unrelated to the cited section.

The second problem is that browsing is hindered by the display of an associated document. The reason is that, when all the information about the source is displayed, the display of currently referred sentences is hindered and browsing and operation become difficult.

Therefore, it is an object of the present invention to provide an information providing system, information providing method, and information providing program capable of presenting only supplementary information to a cited section included in an associated document, providing the supplementary information without having the reader read unnecessary information, and presenting an appropriate amount of information without hindering browsing.

According to a first aspect of the present invention, there is provided an information providing system comprising, based on a cited section in document data (for instance inputted document data), an information creation unit (for instance a supplementary information creation device 4) for extracting an expression that modifies an expression indicating the cited section from other document data (for instance associated document data), and for creating information that indicates an extracted expression; and a display unit for displaying information created by the information creation unit.

It is preferable that the information providing system comprise an associated document determining unit for determining associated document data that includes an expression equal or similar to a cited section as the other document data, and that the information creation unit extracts an expression that modifies an expression equal or similar to the cited section from associated document data determined by the associated document determining unit. According to such a configuration, an expression that modifies an expression equal or similar to the cited section as the target can be extracted.

It is preferable that the information providing system comprise a cited section extraction unit for extracting a cited section in document data. According to such a configuration, a cited section can be automatically extracted.

The information creation unit may create supplementary information that includes an extracted expression, and substitute information that shows information indicating the availability of supplementary information, or that shows a part or the characteristics of the content of an extracted expression as information that indicates the extracted expression. According to such a configuration, appropriate information can be appropriately displayed.

The information creation unit may include a limiting expression extraction unit for extracting an expression that modifies an expression indicating the cited section based on a limiting expression. According to such a configuration, appropriate information can be appropriately displayed.

The information creation unit may include a context analysis unit for extracting an expression that modifies an expression indicating the cited section based on the context. According to such a configuration, appropriate information can be appropriately displayed.

According to a second aspect of the present invention, there is provided an information providing method comprising the steps of: based on a cited section in document data, extracting an expression that modifies an expression indicating the cited section from other document data, and creating information that indicates an extracted expression; and displaying information created.

It is preferable that the information providing method comprises determining, termed as “associated document determining step”, associated document data that includes an expression equal or similar to a cited .section as the other document data, and when the information creating step, wherein in the information creating step, an expression that modifies an expression equal or similar to the cited section be extracted from associated document data determined. According to such a configuration, an expression that modifies an expression equal or similar to the cited section as the target can be extracted.

It is preferable that the information providing method include extracting a cited section in document data. According to such a configuration, a cited section can be automatically extracted.

Supplementary information that includes an extracted expression, and substitute information that shows information indicating the availability of supplementary information, or that shows a part or the characteristics of the content of an extracted expression may be created as information that indicates the extracted expression in the information creating step. According to such a configuration, appropriate information can be appropriately displayed.

An expression that modifies an expression indicating the cited section may be extracted based on a limiting expression in the information creating step. According to such a configuration, appropriate information can be appropriately displayed.

An expression that modifies an expression indicating the cited section may be extracted based on the context in the information creating step. According to such a configuration, appropriate information can be appropriately displayed.

According to a third aspect of the present invention, there are provided an information providing program and a recording medium that stores the information providing program having a computer execute, based on a cited section in document data, an information creating processing of extracting an expression that modifies an expression indicating the cited section from other document data, and creating information that indicates an extracted expression; and a displaying processing of displaying information created.

It is preferable that the information providing program have the computer execute an associated document determining processing of determining associated document data that includes an expression equal or similar to a cited section as the other document data, and in the information creating processing, a processing of extracting an expression that modifies an expression equal or similar to the cited section from associated document data determined. According to such a configuration, an expression that modifies an expression equal or similar to the cited section as the target can be extracted.

It is preferable that the information providing program have the computer execute a cited section extracting processing of extracting a cited section in document data. According to such a configuration, a cited section can be automatically extracted.

The information providing program may have the computer, in the information creating processing, execute creating supplementary information that includes an extracted expression, and substitute information that shows information indicating the availability of supplementary information, or that shows a part or the characteristics of the content of an extracted expression as information that indicates the extracted expression. According to such a configuration, appropriate information can be appropriately displayed.

The information providing program may have the computer, in the information creating processing, execute a limiting expression extracting processing of extracting an expression that modifies an expression indicating the cited section based on a limiting expression. According to such a configuration, appropriate information can be appropriately displayed.

The information providing program may have the computer, in the information creating processing, execute a created analysis processing of extracting an expression that modifies an expression indicating the cited section based on the context. According to such a configuration, appropriate information can be appropriately displayed.

According to the present invention, supplementary information to a cited section can be verified without reading unnecessary information. The reason is that a supplementary information creation unit creates the supplementary information from an expression that actually modifies the cited section.

### BRIEF DESCRIPTION OF THE DRAWINGS

FIG. 1 is a block diagram showing a configuration example of a first mode of an information providing system according to the present invention.

FIG. 2 is a flowchart showing an example of how the information providing system in the first mode operates.

FIG. 3 is an explanation drawing showing examples of citing expressions.

FIG. 4 is an explanation drawing showing examples of source specifying expressions.

FIG. 5 is a block diagram showing a configuration example of a second mode of the information providing system according to the present invention.

FIG. 6 is an explanation drawing showing examples of limiting expressions.

FIG. 7 is a flowchart showing an example of how the information providing system in the second mode operates.

FIG. 8 is a block diagram showing a configuration example of a third mode of the information providing system according to the present invention.

FIG. 9 is a flowchart showing an example of how the information providing system in the third mode operates.

FIG. 10 is a block diagram showing a configuration example of an information providing system according to a first example.

FIGS. 11A and 11B are explanation drawings showing examples of web pages inputted as the inputted document data.

FIG. 12 is an explanation drawing showing an example of a web page determined as the source document.

FIG. 13 is an explanation drawing showing an example of a web page determined as an associated document.

FIG. 14 is a block diagram showing a configuration example of an information providing system according to a second example.

FIG. 15 is an explanation drawing for explaining an example of how the second example of the information providing system operates.

FIG. 16 is an explanation drawing showing an example of a display screen.

### EXPLANATION OF REFERENCE SYMBOLS

1: input device

2: cited section extraction device

3: associated document determining device

4: supplementary information creation device

41: limiting extraction unit

42: context analysis unit

5: display device

100: network control device

200: personal computer

300: display device

400: Internet

600: voice recording device

601: microphone

602: voice recognition device

603: speech database

### PREFERRED MODES

### A Preferred Mode of the Present Invention

For instance, an information providing system in a preferred mode according to the present invention comprises a cited section extraction unit that extracts a cited section from an inputted document, an associated document determining unit that determines an associated document of the cited section, and a supplementary information creation unit that creates supplementary information from the cited section extracted by the cited section extraction unit and the associated document determined by the associated document determining unit, and operates so as to provide information of the associated document, not included in the cited section, which is also information of an expression that modifies a notated section similar or equal to the cited section, as the supplementary information. By employing such a configuration, only supplementary information is provided and the object of the present invention is achieved.

In other words, since the cited section extraction unit extracts a cited section from a document, the associated document determining unit determines an associated document including the cited section, and the supplementary information creation unit creates supplementary information from an expression modifying an expression similar or equal to the cited section in the associated document, a modifying expression can be extracted with an expression similar or equal to the cited section as an object while ignoring unrelated documents. Further, it becomes possible to extract the cited section automatically. Further, if the supplementary information creation unit creates the supplementary information only consisting of expressions that modifies the cited section rather than the entire sentences, the browsing of the currently referred document will not be hindered by the display of the supplementary information.

### Mode 1

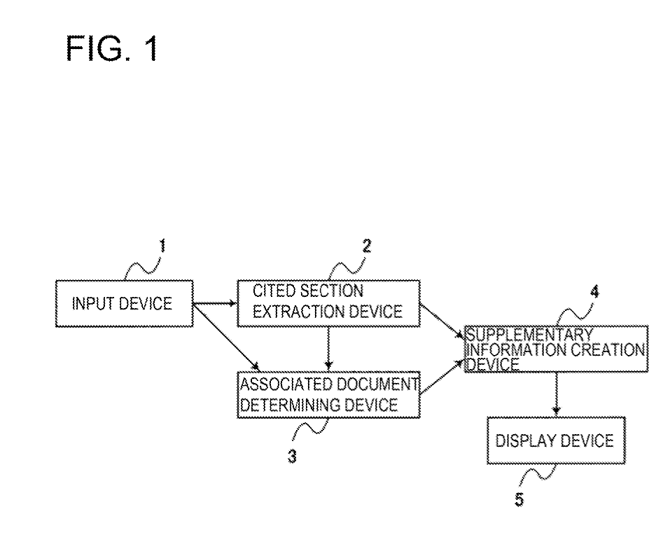

Mode 1 of the present invention will be described with reference to the drawings. FIG. 1 is a block diagram showing a configuration example of the first mode of the information providing system according to the present invention. The information providing system shown in FIG. 1 comprises an input device 1, a cited section extraction device 2, an associated document determining device 3, a supplementary information creation device 4, and a display device 5.

The input device 1 is realized by input devices such as a keyboard and mouse, and inputs the data of the document citing a section. In other words, the input device 1 inputs the document data including the cited section.

The cited section extraction device 2 extracts the cited section from the document data (sometimes referred to as “inputted document data”) inputted by the input device 1. For instance, by analyzing a notation clearly indicating citation such as a tag in an HTML document, the cited section extraction device 2 extracts the cited section from the inputted document data inputted by the input device 1. Further, for instance, by analyzing an expression indicating citation in terms of text expression, the cited section extraction device 2 extracts the cited section. The cited section extraction device 2 outputs information indicating the cited section extracted to the associated document determining device 3 and the supplementary information creation device 4.

The associated document determining device 3 determines an associated document and a notated section equal or similar to the cited section in the associated document according to the inputted document data and the cited section. Further, the associated document determining device 3 outputs information indicating the determined associated document and the notated section equal or similar to the cited section in the associated document to the supplementary information creation device 4.

In other words, the associated document determining device 3 determines associated document data based on the inputted document data inputted by the input device 1 or the cited section extracted by the cited section extraction device 2, or both the inputted document data and the cited section. For instance, the associated document determining device 3 extracts a description about the cited section from the inputted document data, and determines whether or not the document being searched is an associated document based on the extracted description. The description about the cited section is, for instance, information indicating the source document of the cited section. The associated document determining device 3 determines a notated section similar or equal to the cited section as the description about the cited section in an associated document.

Based on the cited section and sentences in the associated document, the supplementary information creation device 4 extracts a section (sometimes referred to as “modifying expression section” hereinafter) including an expression modifying the notated section similar or equal to the cited section from the associated document, and creates supplementary information. In other words, the supplementary information creation device 4 compares the cited section extracted by the cited section extraction device 2 with the associated document data determined by the associated document determining device 3, and extracts an expression modifying the notated section similar or equal to the cited section in the associated document as supplementary information. The supplementary information is information that includes the expression extracted by the supplementary information creation device 4. Here, the expression extracted as the supplementary information includes a text sentence and information indicated by an HTML tag. For instance, if a <DEL> tag indicates that a cited section in an HTML document has been deleted, information of the <DEL> tag will be supplementary information.

The display device 5 is realized by a display device such as a liquid crystal display device and organic EL display device, and displays the supplementary information. When the display device 5 is a display device, it displays the supplementary information by displaying a character string, symbol, image, and video representing the supplementary information, or by using a different color and font from the currently displayed contents.

The information providing system can be realized by a computer, and each constituent element, i.e., the cited section extraction device 2, the associated document determining device 3, and the supplementary information creation device 4, can be realized as programs that have a central processing unit (CPU) of the computer realize the functions described above. The facts that each element constituting the information providing system can be realized by a computer and that each element can be realized as a program apply to other modes.

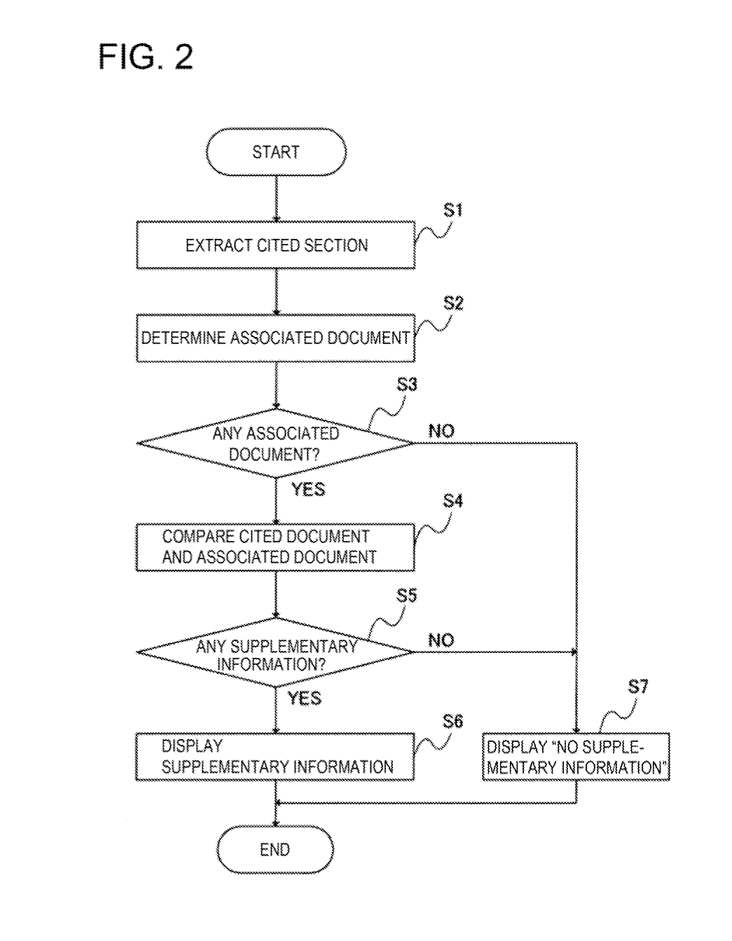

Next, the operation of the first mode will be described with reference to the drawings. FIG. 2 is a flowchart showing an example of how the information providing system in the first mode operates.

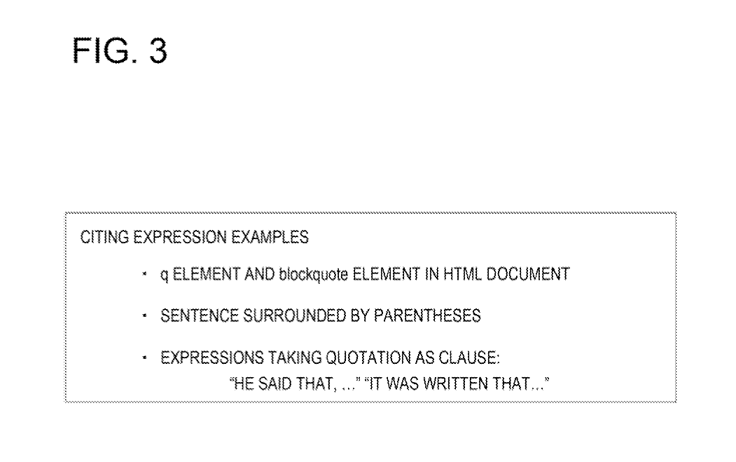

First, the cited section extraction device 2 receives an inputted document from the input device 1. The cited section extraction device 2 extracts a cited section by taking out a section written in a citing expression that functions to indicate citation from the inputted document (step S1). FIG. 3 is an explanation drawing showing examples of the citing expressions. As shown in FIG. 3, the citing expressions include q elements and blockquote elements in HTML documents, sentences surrounded by parentheses, and expressions that take a quotation as a clause, such as “he said that” or “it was written that.” For instance, the cited section extraction device 2 stores setting information that includes the citing expressions shown in FIG. 3 as cited section extraction rules in a memory device. The cited section extraction device 2 extracts a cited section according to the cited section extraction rules indicated in the setting information.

Next, the associated document determining device 3 executes processing that determines a document including an expression similar or equal to the cited section as an associated document (step S2), and determines whether or not any associated document exists (step S3).

As a method for determining an associated document, for instance, there is a method that determines whether or not a document being searched is an associated document by searching for equal or similar expressions based on the character strings of the cited section. In this case, for instance, the name of the document publisher, the date and time the document is published, and the document kind indicating the source of the document from which the section is cited are extracted from a passage that refers to the cited section in the inputted document. Utilizing the extracted information, the target document is searched, and sentences can be narrowed down by categorizing search results.

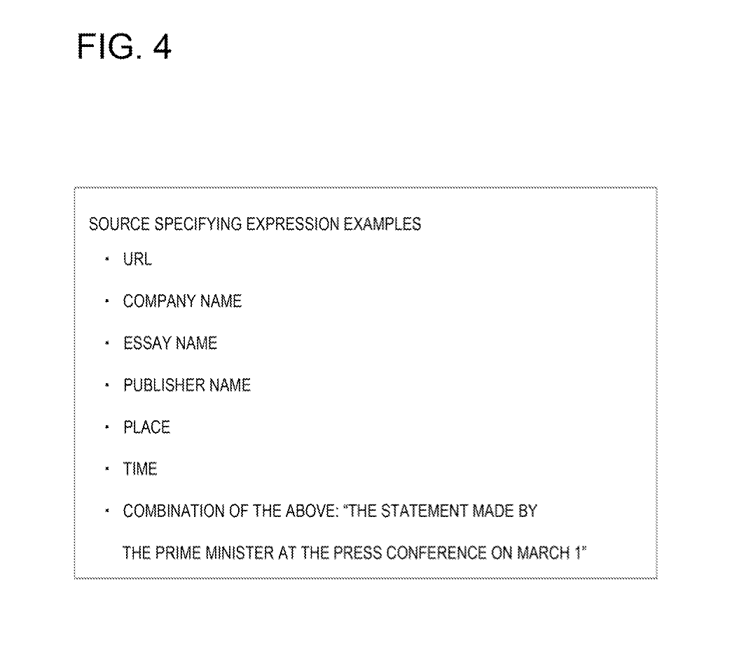

Further, by referring to a source specifying expression that indicates the source in the inputted document, the source document can be determined. FIG. 4 is an explanation drawing showing examples of the source specifying expressions. As shown in FIG. 4, the source specifying expressions include, for instance, URL, the name of the company, the name of the essay, the name of the document publisher, the place, the time, and combinations of these pieces of information, and for instance, it could be something such as “the statement made by the Prime Minister at the press conference on March 1.” Further, both character string search and the source specifying expression can be utilized. For instance, when the inputted document includes a character string “URL,” the associated document determining device 3 extracts the character string following “URL,” access a website according to the extracted character string, and collects the source document.

Here, the target document being searched may be, for instance, a web page on the Internet. Or it may be a document stored in a database.

When it is determined that an associated document exists in the step S3 (Yes), the supplementary information creation device 4 compares the cited section to the associated document, investigates whether or not there is any notated section modifying the cited section in the associated document, extracts it when there is one, and creates supplementary information (step S4). The supplementary information creation device 4 determines whether or not there is supplementary information (step S5), and when it is determined there is one (Yes), the supplementary information creation device 4 has the display device 5 display the supplementary information (step S6).

On the other hand, when it is determined that there is no associated document in the step S3 (No) or when it is determined that there is no supplementary information in the step S5 (No), the supplementary information creation device 4 has the display device 5 display no supplementary information or display a statement saying that there is no supplementary information (step S7).

Next, the effects of the first mode will be described. In the first mode, since it is configured so that the cited section extraction device 2 extracts a cited section, the cited section in a text can be obtained without having the reader specify the section, and supplementary information to the cited section can be provided.

Further, since the associated document determining device 3 determines a document that includes an expression similar or equal to the cited section as an associated document, the information of a document related to expressions in the cited section can be provided as supplementary information without having an unrelated document as an object.

Further, since the supplementary information creation device 4 compares the information of an associated document to the cited section and provides only supplementary information created from an expression that modifies the cited section, the reader does not have to read unnecessary information, and an appropriate amount of information can be provided to the reader. Further, by displaying only supplementary information, the area required for displaying the information becomes smaller compared to cases where the entire associated document is displayed, and the supplementary information can be provided without hindering the display of the currently browsed document.

As a variation of the first mode, the cited section extraction device 2 may have a human reader explicitly select a cited section instead of automatically extracting a cited section from an inputted document. In this configuration, by displaying only supplementary information to the cited section selected by the reader, appropriate supplementary information can be provided without displaying supplementary information to an irrelevant cited section. Further, since even a cited expression in a text can be appropriately selected by the reader, associated documents can be determined more accurately.

It may be configured so that the reader can further correct the cited section by presenting the cited section extracted by the cited section extraction device 2 to the reader. In this case, the reader does not have to do anything when the cited section has been extracted accurately, and the reader accurately specifies the cited section only when correction is necessary. As a result, associated documents can be determined appropriately.

There are cases where the associated document determining device 3 detects a plurality of associated documents. If all the associated documents detected are objects from which supplementary information is extracted, supplementary information can be created from all the associated documents detected. To the supplementary information extracted from each associated document, information indicating from which associated document the supplementary information is extracted may be added.

As a variation of the first mode, when the associated document determining device 3 detects a plurality of associated documents, the number of associated documents from which supplementary information is extracted, out of the detected associated documents, may be limited.

When the number of associated documents froth which supplementary information is extracted is limited, a weight of importance is given to each document, and documents having a weight greater than a reference value may be selected. As a method for weighting documents, for instance, there is a method in which documents are weighted according to how recent the document is created, the number of times the document is referred to, the number of times the document quotes from other documents, the categorization of the publisher, and the degree of similarity to the currently referred document. In this case, since associated documents considered to be more important become the targets from which supplementary information is extracted, supplementary information considered to be more important is presented and supplementary information considered to be unimportant is not displayed.

Or documents may be given a ranking according to the weight of importance, and a predetermined number of high-ranking documents may be selected. in this case, since the amount of associated documents from which supplementary information is extracted is always less than the predetermined number, the load of processing required through the display of supplementary information can be controlled so that it does not become too large. Further, the amount of displayed supplementary information can be controlled so that it does not become too large.

Further, the single most important document may be selected. In this case, the amount of supplementary information is small, but deemed important, more detailed supplementary information can be displayed without hindering the browsing of the document even less.

Further, only the source document from which the cited section is cited may be selected as an associated document. As a method for determining an associated document as the source document, when there is a source specifying expression in the cited section, there is a method in which a document specified by the source specifying expression is determined to be the source document. Further, there is a method in which the creation dates of associated documents are obtained and the document having the oldest creation date is determined to be the source document. In this configuration, by looking at the display of supplementary information included in the source document, the reader can accurately understand the original information of the cited section cited by the currently referred document.

Further, in addition to a plurality of associated documents or to a selected single associated document, supplementary information may be created from an associated document from which the cited section is cited, i.e., the source document.

### Mode 2

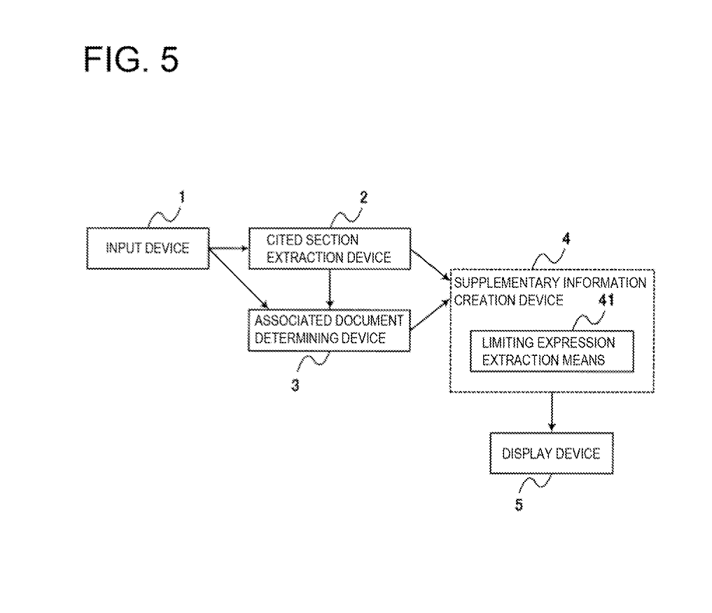

Next, a second mode of the present invention will be described with reference to the drawings. FIG. 5 is a block diagram showing a configuration example of the second mode of the information providing system according to the present invention. The second mode differs from the first mode shown in FIG. 1 in that the supplementary information creation device 4 comprises a limiting expression extraction unit 41.

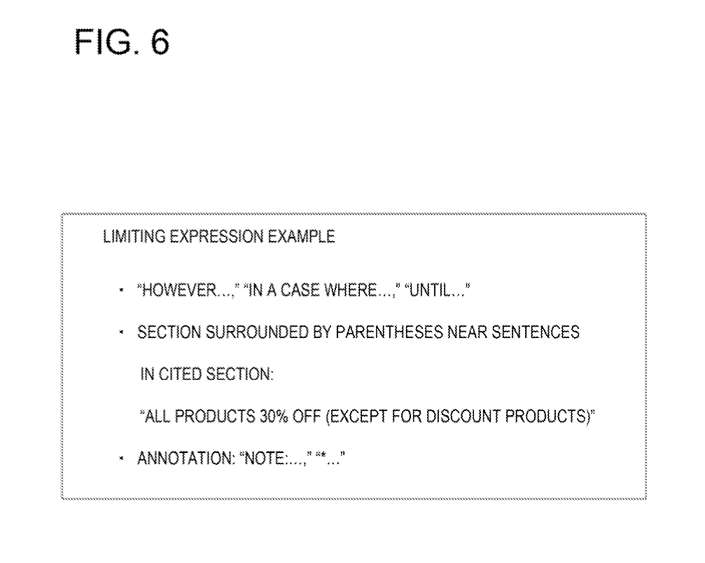

The limiting expression extraction unit 41 extracts a section that gives modification such as conditions, corrections, and added information to an expression similar or equal to the cited section from an associated document as a limiting expression for the cited section. Such a limiting expression can be extracted by paying attention to the existence of a clue expression indicating that it is a limiting expression in particular passages in a document such as adjacent sections to the cited section, the end of a page, the end of the document, and annotations. FIG. 6 is an explanation drawing showing examples of limiting expressions. As shown in FIG. 6, the limiting expressions include, for instance, expressions appearing in a text with clues such as “however . . . ,” “in a case where . . . ,” and “until . . . ,” a section surrounded by parentheses adjacent to the sentences in the cited section such as “(except for discount products)” in “all products 30% off (except for discount products),” and annotations, corrections, and added information guided by clue expressions such as “note: . . . ,” “* . . . ,” “correction: . . . ,” “appendix: . . . ,” and “supplement: . . . ” For instance, the limiting expression extraction unit 41 stores setting information that includes the limiting expressions shown in FIG. 6 as modifying expression section extracting rules in a memory device in advance. The limiting expression extraction unit 41 extracts a limiting expression as a modifying expression section according to the modifying expression section extracting rules indicated by the setting information.

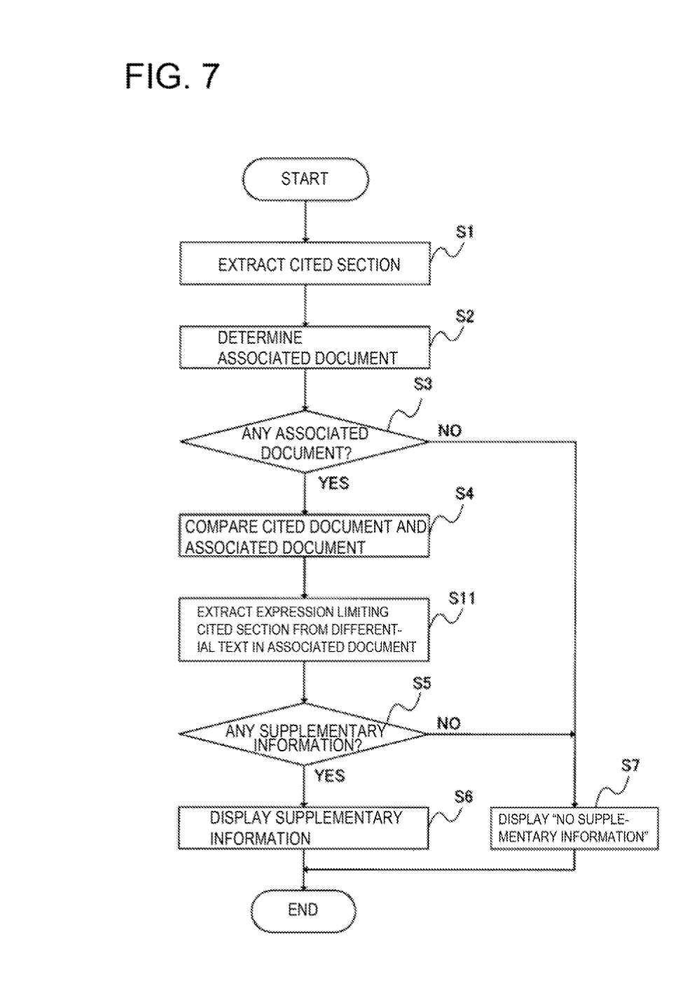

Next, the operation of the second mode will be described with reference to the drawings. FIG. 7 is a flowchart showing an example of how the information providing system in the second mode operates. The operation of extracting a cited section and an associated document in steps S1 through S3 shown in FIG. 7 is the same as that in the first mode, therefore explanation is omitted.

The supplementary information creation device 4 compares the cited section to the associated document, and extracts a differential text only included in the associated document (step S4). Here, the limiting expression extraction unit 41 checks whether or not there is any section that limits the cited section using a limiting expression in the differential text (step S11). In the step S11, if there is a section that limits the cited section using a limiting expression, the limiting expression extraction unit 41 extracts it and creates supplementary information.

The operation of displaying the supplementary information in steps S5 through S7 is the same as that in the first mode, therefore explanation is omitted.

Next, the effects of the second mode will be described. In the second mode, by displaying only a section (supplementary information) that modifies a cited section using a limiting expression in an associated document, only appropriate supplementary information limiting regarding the cited section can be presented to the reader. Further, by displaying only supplementary information limiting regarding the cited section, the area required for displaying the information becomes smaller, compared to the case where supplementary information including unlimited information is displayed, and the supplementary information can be provided without hindering the display of the text that quotes the cited section.

### Mode 3

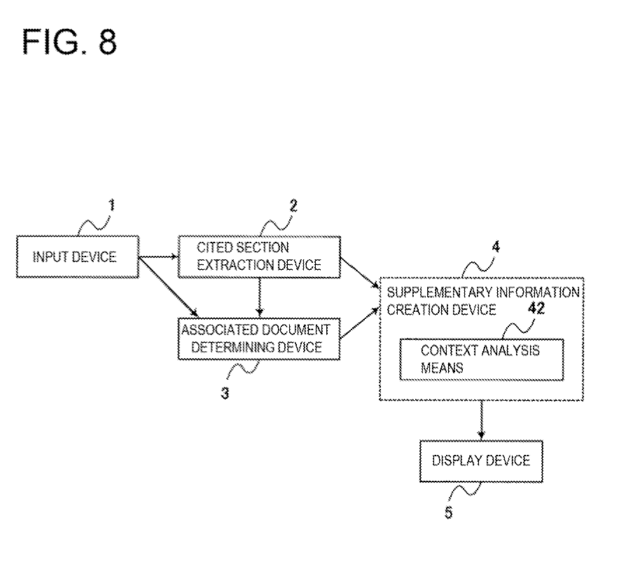

Next, a third mode of the present invention will be described with reference to the drawings. FIG. 8 is a block diagram showing a configuration example of the third mode of the information providing system according to the present invention. The third mode differs from the first mode shown in FIG. 1 in that the supplementary information creation device 4 comprises a context analysis unit 42.

The context analysis unit 42 extracts a sentence or a part of it in a context that modifies an expression similar or equal to the cited section from information in an associated document as a modifying expression section, and creates supplementary information. A section that modifies an expression similar or equal to the cited section can be determined using a discourse analysis technology and anaphora analysis technology. As an example of context information, there is a reference relation caused by a modification relation and pronoun. For instance, when a person referred to in the cited section is referred to again by a pronoun later in the text, it can be determined that the contents later in the text is in a context that modifies the cited section by determining that the person referred to by the pronoun is indeed the one in cited section using an anaphora analysis technology. More concretely, assuming that the content of the cited section is, “Mr. Gore lectured at a symposium on environmental issues,” if there is a sentence that goes “he was the Vice President under the Clinton administration” later in the text, it is determined that the pronoun “he” later in the text refers to “Mr. Gore” in the cited section, and it is also determined that there is information that supplements the cited section later in the text.

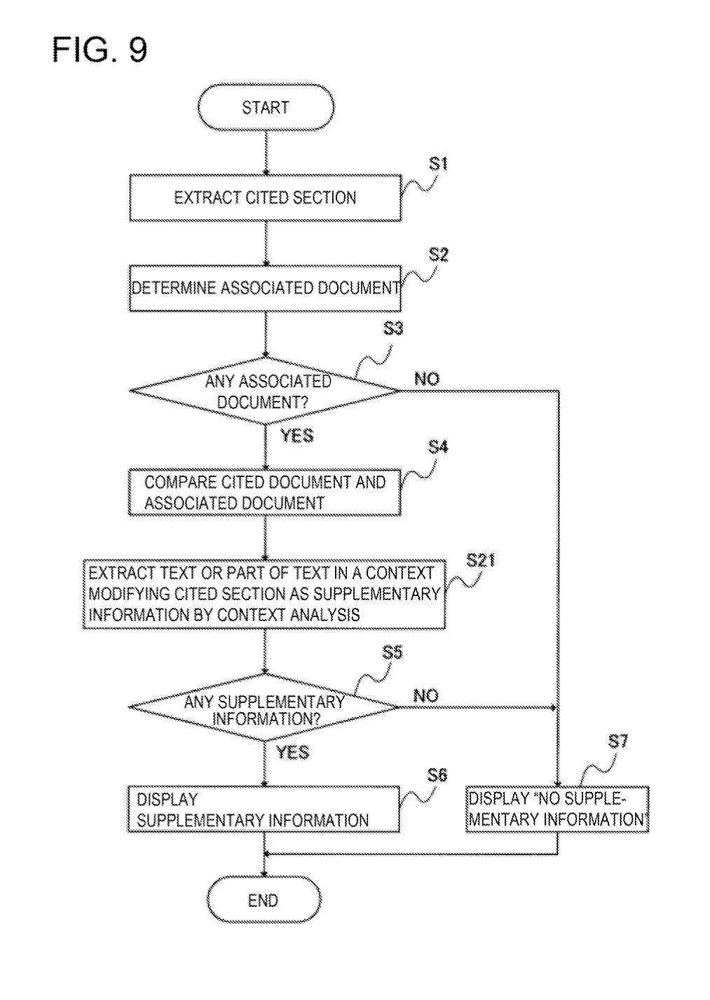

Next, the operation of the third mode will be described with reference to the drawings. FIG. 9 is a flowchart showing an example of how the information providing system in the third mode operates. The operation of extracting a cited section and an associated document in steps S1 through S3 shown in FIG. 9 is the same as that in the first mode, therefore explanation is omitted.

The supplementary information creation device 4 compares the cited section to the associated document, and extracts a differential text only included in the associated document (step S4). Here, the context analysis unit 42 checks whether or not there is any expression in a context that modifies an expression similar or equal to the cited section by performing context analysis on the differential text (step S21). When an expression in a context that modifies an expression similar or equal to the cited section is found in the step S21, the context analysis unit 42 extracts it and creates supplementary information.

The operation of displaying the supplementary information in steps S5 through S7 is the same as that in the first mode, therefore explanation is omitted.

Next, the effects of the third mode will be described. Since a sentence or a part of it in a context that modifies the cited section is extracted as supplementary information through context analysis in the third mode, only more appropriate supplementary information can be presented to the reader. Further, the area required for displaying the supplementary information becomes smaller, compared to the case where a section contextually unrelated to the cited section is displayed, and the supplementary information can be provided without hindering the display of the browsed document.

As a variation of the third mode, if the range from which context information is extracted is limited to a few sentences before and after the cited section, or to the paragraph including the cited section, information in passages distant from the cited section in an associated document will not be employed as supplementary information. As a result, information having little relevance can be reduced. Further, the time required for context analysis is reduced, and the supplementary information can be outputted at high speed.

Further, the limiting expression extraction unit 41 of the second mode and the context analysis unit 42 of the third mode may be applied simultaneously, and supplementary information extracted by each unit may he outputted.

### EXAMPLE 1

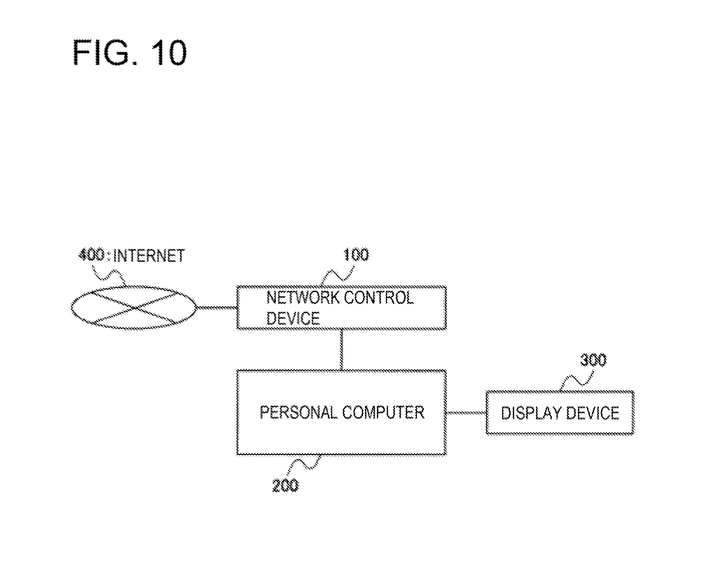

Next, examples of the first to the third mode will be described. FIG. 10 is a block diagram showing a configuration example of an information providing system according to a first example. The information providing system shown in FIG. 10 comprises a network control device 100, a personal computer 200, and a display device 300.

First, an example of the first mode will be described. The network control device 100 is connected to the Internet 400. The network control device 100 receives a web page as inputted document data via the Internet 400 as the input device 1 shown in FIG. 1, and outputs it to the cited section extraction device 2. The personal computer 200 includes the cited section extraction device 2, the associated document determining device 3, and the supplementary information creation device 4 shown in FIG. 1. The display device 300 displays supplementary information as the display device 5 shown in FIG. 1.

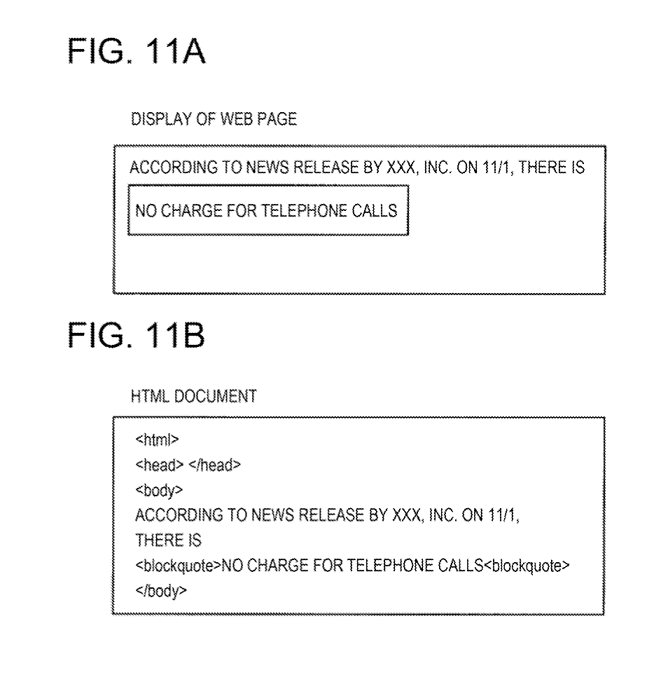

Next, the operation of the first example of the information providing system will be described. The network control device 100 receives a web page as inputted document data via the Internet 400. FIGS. 11A and 11B are explanation drawings showing examples of the web pages inputted as the inputted document data. FIG. 11A shows an example of a web page including a cited section “no charge for telephone calls.” Further, FIG. 11B shows an example of an HTML file including the cited section “no charge for telephone calls” quoted by blockquote elements. The network control device 100 outputs the inputted web page to the cited section extraction device 2 of the personal computer 200.

The cited section extraction device 2 detects the blockquote elements from the inputted web page, and extracts the cited section. In the example shown in FIG. 11B, “no charge for telephone calls” is extracted as the cited section.

The associated document determining device 3 extracts the company name “XXX, Inc.,” the publishing date “November 1,” and the document name “News release” written immediately before the blockquote element, and search web pages on the Internet using the character strings extracted and the character strings in the cited section as search keywords. Then the associated document determining device 3 determines a plurality of associated documents from search results. Here, the source document may be treated differently from the other associated documents.

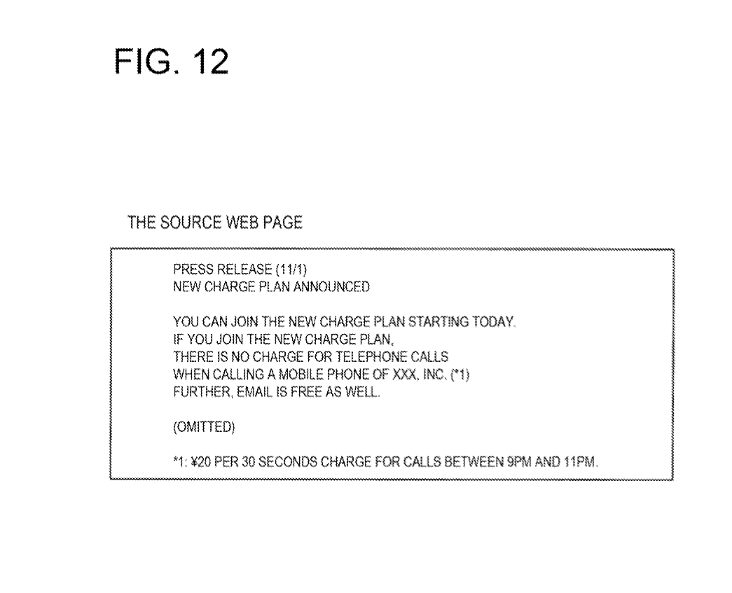

Here, it is assumed that the web page (sometimes referred to as “the source web page” hereinafter) is able to be determined as the source document based on the company name, the publishing data, and the document name. FIG. 12 is an explanation drawing showing an example of the web page determined as the source document. The associated document determining device 3 searches for the same character strings found in the cited section in the source web page, and determines where the cited section has been taken from.

For instance, with reference to FIG. 11, the cited section is “no charge for telephone calls.” Therefore, the associated document determining device 3 searches in the source document shown in FIG. 12 based on the character string “no charge for telephone calls.” FIG. 12 shows a case where the source document includes the cited section character string “no charge for telephone calls.”

The supplementary information creation device 4 receives the cited section character strings of the inputted web page from the cited section extraction device 2, and receives the source web page and information indicating from where the cited section has been taken in the source web page from the associated document determining device 3. Then, the supplementary information creation device 4 extracts information that modifies the cited section from the source web page as supplementary information based on the cited section and the text in the source web page.

Next, an example of the second mode will be described. In the second mode, the limiting expression extraction unit 41 extracts sections that modify the cited section in the source web page with limiting expressions such as “if you join the new charge plan” that includes a limiting expression “if,” adding a limit to the cited section, “when calling a mobile phone of XXX, Inc.” that includes a limiting expression “when,” and “¥20 per 30 seconds charge for calls between 9PM and 11PM” from a limiting expression “*1” indicating that there is an annotation as supplementary information (refer to FIG. 12).

Next, an example of the third mode will be described. In the third mode, the context analysis unit 42 extracts a section in a modification relation with the cited section in the same sentence as the cited section such as “in the case of the new charge plan, when calling a mobile phone of XXX, Inc.” and “further, email is free as well” that explains “the new charge plan” in parallel with the cited section as supplementary information (refer to FIG. 12).

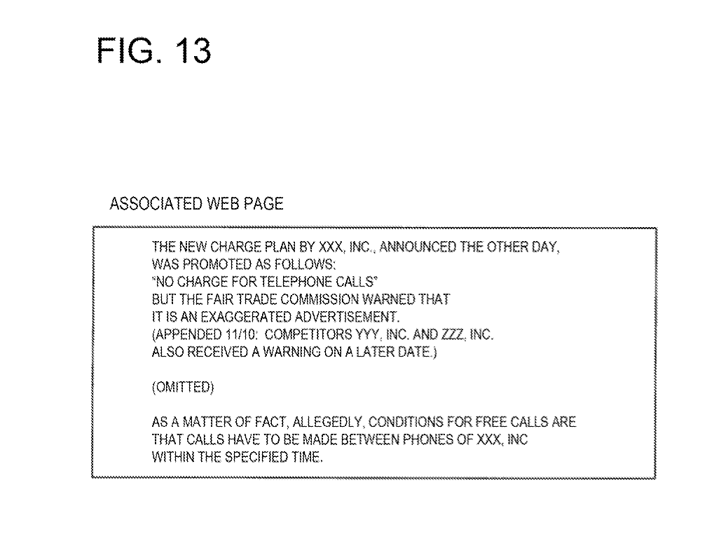

Supplementary information can also be obtained when an associated document other than the source document is obtained. FIG. 13 is an explanation drawing showing an example of a web page determined as an associated document. The associated document determining device 3 detects the cited section “no charge for telephone calls” by performing a character string search in the associated document.

With reference to FIG. 13, the supplementary information creation device 4 extracts “the new charge plan by XXX, Inc., announced the other day, was promoted as follows” that includes “as follows” referring to the cited section in a reference relation as supplementary information. Further, “the Fair Trade Commission warned that it is an exaggerated advertisement” connected with the conjunction “but” is extracted as supplementary information. Further, “appended November 10: competitors YYY, Inc. and ZZZ, Inc. also received a warning on a later date” that includes a limiting expression “appended” is extracted as supplementary information.

Here, the associated document determining device 3 may further search for an expression similar to the cited section in the associated document, and the supplementary information creation device 4 may extract supplementary information to the searched similar expression as supplementary information to the cited section. In the example shown in FIG. 13, the associated document determining device 3 obtains “free calls” as a similar expression to “no charge for telephone calls,” and the supplementary information creation device 4 extracts supplementary information to the similar expression: “allegedly, conditions for free calls are that calls have to be made between phones of XXX, Inc within the specified time.”

Having obtained supplementary information to the source, the display device 300 displays the obtained supplementary information. In displaying the supplementary information, the display device 300 may display the text of the associated document, i.e., the supplementary information, as it is. In this case, the reader is able to confirm the actual text in the associated document.

Or expressions in the supplementary information section in the associated document may be changed and revised into more readable expressions. For instance, pronouns may be supplemented, unnecessary expressions may be deleted, supplementary information extracted as phrases may be edited into a form of sentence, supplementary information constituting a plurality of sentences and supplementary information having the same contents may be summarized, and supplementary information in a foreign language may he translated. In this case, supplementary information will be more easily understood by the reader.

Further, instead of the text representing the supplementary information, the displayed information may be a substitute display (substitute information) indicating whether or not there is supplementary information, or showing a part or just the characteristics of the extracted expressions. The contents of the substitute display includes, for instance, the availability of supplementary information, a limiting expression, the availability of update information since the cited section was cited or since the last time it was referred to, and the kind of the contents. The substitute display may be represented by character strings and icons, or by changing the font and color of the text of the cited section. The substitute display may have a function of displaying detailed supplementary information. Further, the substitute display may have a link to a passage including supplementary information in an associated document.

For instance, when the source document or an associated document includes the limiting expression “in the case where” shown in the example of FIG. 12, whether or not there is any limiting expression can be indicated by a character string such as “limiting” or “l” indicating the existence of a limiting expression, or a logotype representation of the character string. Further, for instance, when there is updated supplementary information such as the limiting expressions “appended November 10: competitors YYY, Inc. and ZZZ, Inc. also received a warning later” in the example of FIG. 13, the availability of updated supplementary information can be indicated by character strings such as “update” and “new,” logotype representations of these character strings, and a character string “November 10” further indicating the update date.

As described, by displaying information about the availability of supplementary information and its kind, the display becomes simpler than the case where the supplementary information is displayed as it is, and it is possible to display the supplementary information without hindering the display of the currently browsed document. The reader is able to select only a cited section having supplementary information and verify the detailed supplementary information and the associated document. This becomes more effective when there are many cited sections in the currently browsed document.

The supplementary information may be displayed, for instance, immediately before or after the cited section, immediately before or after the row that includes the cited section on the inputted web page, or the supplementary information may be inserted and displayed in the left and right margins. Further, it may be displayed in the display area of another screen. Or it may be displayed in another window.

Further, the supplementary information may be displayed simultaneously with the inputted web page. In this case, the reader is able to browse the supplemented web page including the supplementary information right away. Meanwhile, the supplementary information may be displayed when the reader points to the cited section. The reader is able to point to the cited section by, for instance, moving the cursor closer to it. In this case, the supplementary information can be displayed only when the reader requests that the supplementary information to the cited section be displayed, without hindering the browsing of the inputted web page.

### EXAMPLE 2

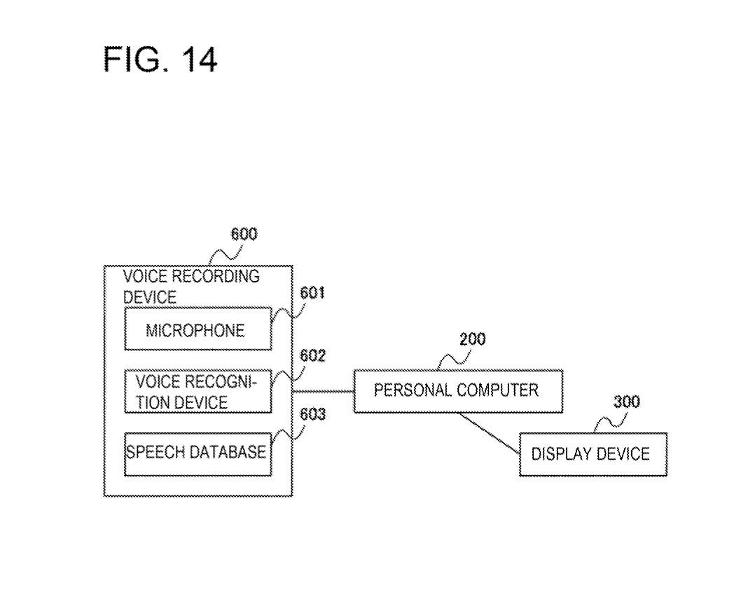

Next, an example of the second mode [a second example] will be described. FIG. 14 is a block diagram showing a configuration example of an information providing system according to a second example. The information providing system shown in FIG. 14 comprises a voice recording device 600, the personal computer 200, and the display device 300.

For instance, the voice recording device 600 is set up in a conference room. The voice recording device 600 includes a microphone 601, a voice recognition device 602, and a speech database 603, and functions as the input device 1 shown in FIG. 1. The microphone 601 is a sound input device, which receives the sound of speech during a conference, converts the sound into an electric signal, and outputs the result to the voice recognition device 602. The voice recognition device 602 converts the electric signal outputted by the microphone 601 into a text database by performing voice recognition processing on it, and has the speech database 603 store it as inputted document data. Further, for instance, the speech database 603 stores text data regarding speeches during past conferences as document data that can be searched as associated document data.

The personal computer 200 includes the cited section extraction device 2, the associated document determining device 3, and the supplementary information creation device 4 shown in FIG. 1. The display device 300 displays supplementary information as the display device 5 shown in FIG. 1.

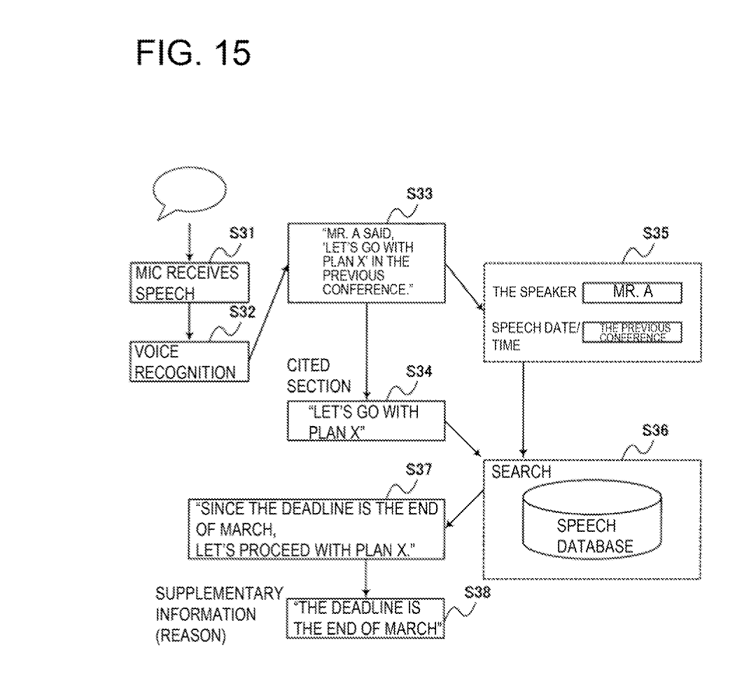

Next, the operation of the second example of the information providing system will be described. FIG. 15 is an explanation drawing for explaining an example of how the second example of the information providing system operates. The microphone 601 receives a speech (step S31), and the voice recognition device 602 performs the voice recognition processing (step S32) and converts the speech into text data (step S33). Below, an explanation will be made using an example in which the speech converted into text data by the voice recognition device 602 is “Mr. A said, ‘Let's go with Plan X’ in the previous conference.”

Here, the cited section is “Let's go with Plan X.” Therefore, the cited section extraction device 2 analyzes the sentence structure of the speech and extracts the cited section “Let's go with Plan X” (step S34). The associated document determining device 3 extracts “Mr. A” as the speaker and “the previous conference” as the date of the speech (step S35). Then, the associated document determining device 3 searches in the speech database 603 using the extracted character string and the cited section character string as search keywords (step S36), and extracts, for instance, speech data including a similar expression “Since the deadline is the end of March, let's proceed with Plan X” (step S37). Further, the associated document determining device 3 determines “let's proceed with Plan X” as a notated section similar to the cited section.

The supplementary information creation device 4 extracts the reason clause “Since the deadline is the end of March” as a section that modifies the notated section similar to the cited section with a limiting expression “since” from the speech data, and creates supplementary information, which is “the deadline is the end of March” indicating the reason, as supplementary information (step S38).

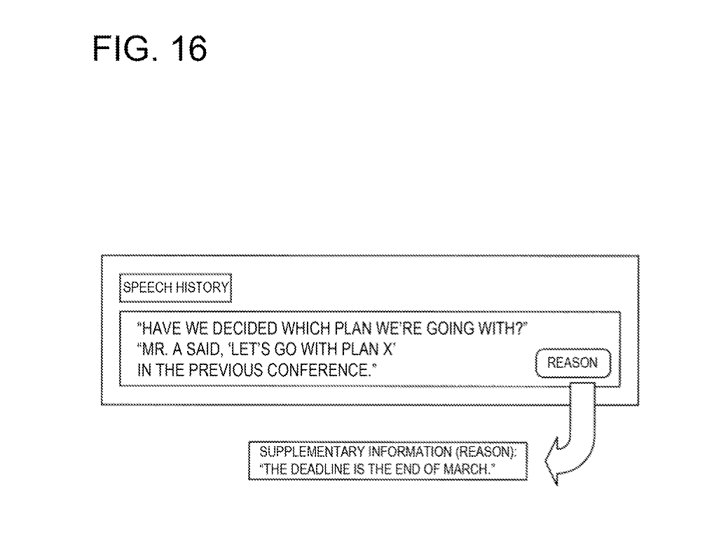

FIG. 16 is an explanation drawing showing an example of a display screen. The display device 300 functioning as the display device 5 displays, for instance, the text of the speech from which the supplementary information is created, and a button indicating “Reason” as the kind of the supplementary information (refer to FIG. 16). For instance, when the reader presses the button provided corresponding to the speech, the display device 300 displays the supplementary information of the speech corresponding to the button (refer to FIG. 16). For instance, if a conference participant wants to know the reason why Mr. A said, “Let's go with Plan X,” in the previous conference, he can find out the reason (because “the deadline is the end of March”) by, for instance, pressing the button and having the detail of the supplementary information displayed.

Here, the input (i.e., the inputted document data including the cited section) may be in the form of a video converted into a text by voice recognition processing. Further, the data accumulated in the speech database may be voice data, associated documents may be determined by specifying information such as the speaker and date/time, and the voice recognition processing may be performed only when supplementary information is created. In this case, the database can easily be utilized when there is no time to perform the voice recognition processing such as when the cited section is cited from a conference that is currently in progress.

Further, when an associated document is determined based on the cited section, an associated document that includes an equal expression may be searched first, and then when it is not found, an associated document that includes a similar expression may be searched. Similar expressions include, for instance, notational variations, interchangeable synonyms, and different orders of phrases. If a similar expression cannot be found, the definition of the similar expression may be widened. In this structure, an associated document can be determined more appropriately when the citation is not accurate. Further, at the point when no equal expression has been found, the reader may be presented with a question as to whether or not a similar expression should be searched.

### INDUSTRIAL APPLICABILITY

The present invention can be applied to use such as verifying supplementary information included in an associated document from a cited section included in a text on the Web. Further, the present invention can be applied to use such as confirming the reliability of a news article in a newspaper that includes a remark by verifying the original intentions of the remark in the original recording and recorded video of the remark.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1-18. (canceled)

19. An information providing system comprising:
an associated document determining unit that determines at least one piece of associated document data that includes an expression equal or similar to a cited section based on a cited section in document data;
a limiting expression extraction unit that extracts an expression that corresponds to a condition for, correction for, addition to, or annotation to an expression equal or similar to said cited section from associated document data determined by said associated document determining unit;
an information creation unit that creates an expression extracted by said limiting expression extraction unit or information regarding this expression as information to be displayed; and
a display unit that displays information created by said information creation unit.

20. The information providing system as defined in claim 19, wherein said information creation unit creates substitute information that shows information indicating the availability of an expression extracted by said limiting expression extraction unit, or that shows a part or the characteristics of the content of an expression extracted by said limiting expression extraction unit.

21. An information providing method comprising:
determining at least one piece of associated document data that includes an expression equal or similar to a cited section based on a cited section in document data, termed as “associated document determining step”;
extracting an expression that corresponds to a condition for, correction for, addition to, or annotation to an expression equal or similar to said cited section from associated document data determined by said determining step, termed as “limiting expression extracting step”;
creating an expression extracted or information regarding this expression as information to be displayed, termed as “information creating step”; and
displaying information created, termed as “displaying step”.

22. The information providing method as defined in claim 21, wherein, in said information creating step, substitute information that shows information indicating the availability of an expression extracted by said limiting expression extracting step, or that shows a part or the characteristics of the content of an expression extracted is created.

23. An information providing program having a computer execute:
determining at least one piece of associated document data that includes an expression equal or similar to a cited section based on a cited section in document data, termed as “associated document determining processing”;
extracting an expression that corresponds to a condition for, correction for, addition to, or annotation to an expression equal or similar to said cited section from associated document data determined, termed as “limiting expression extracting processing”;
creating an expression extracted or information regarding this expression as information to be displayed, termed as “information creating processing”; and
displaying information created, termed as “displaying processing”.

24. The information providing program as defined in claim 23, having said computer, in said information creating processing, execute a processing of creating substitute information that shows information indicating the availability of an expression extracted, or that shows a part or the characteristics of the content of an expression extracted by said limiting expression extracting processing.

25. The information providing system as defined in claim 19, comprising:
a context analysis unit that extracts an expression that indirectly modifies or supplement an expression equal or similar to said cited section using a pronoun from associated document data determined by said associated document determining unit, instead of said limiting expression extraction unit; wherein
said information creation unit creates an expression extracted by said context analysis unit or information regarding this expression as information to be displayed.

26. The information providing system as defined in claim 25, wherein said information creation unit creates substitute information that shows information indicating the availability of an expression extracted by said context analysis unit, or that shows a part or the characteristics of the content of an expression extracted by said context analysis unit.

27. The information providing method as defined in claim 21, comprising:
extracting, termed as “context analysis step”, an expression that indirectly modifies or supplement an expression equal or similar to said cited section using a pronoun from associated document data determined by said associated document determining step, instead of said limiting expression extracting step; wherein
an expression extracted by said context analysis unit or information regarding this expression is created as information to be displayed, in said information creating step.

28. The information providing method as defined in claim 27, wherein substitute information that shows information indicating the availability of an expression extracted by said context analysis steps, or that shows a part or the characteristics of the content of an expression extracted by said context analysis steps is created in said information creating step.

29. The information providing program as defined in claim 23, having said computer execute:
instead of said limiting expression extracting processing, a context analysis processing of extracting an expression that indirectly modifies or supplement an expression equal or similar to said cited section using a pronoun from associated document data determined by said associated document determining processing; wherein
an expression extracted by said context analysis unit or information regarding this expression is created as information to be displayed in said information creating processing.

30. The information providing program as defined in claim 29, wherein substitute information that shows information indicating the availability of an expression extracted by said context analysis unit, or that shows a part or the characteristics of the content of an expression extracted by said context analysis processing, in said information creating processing.
